(19) United States
(12) Patent Application Publication
(10) Pub. No.: US 2025/0373524 A1
(43) Pub. Date: Dec. 4, 2025

(54) TRAFFIC MONITORING DEVICE, TRAFFIC MONITORING METHOD, AND TRAFFIC MONITORING PROGRAM

(71) Applicant: NIPPON TELEGRAPH AND TELEPHONE CORPORATION, Tokyo (JP)

(72) Inventors: Chiharu MORIOKA, Tokyo (JP); Yuhei HAYASHI, Tokyo (JP); Masato YAMADA, Tokyo (JP); Yuki MIYOSHI, Tokyo (JP); Akinori FURUTA, Tokyo (JP); Satomi INOUE, Tokyo (JP); Atsushi SUTO, Tokyo (JP)

(73) Assignee: NIPPON TELEGRAPH AND TELEPHONE CORPORATION, Tokyo (JP)

(21) Appl. No.: 18/872,804

(22) PCT Filed: Jun. 9, 2022
(86) PCT No.: PCT/JP2022/023372

§ 371 Date: Dec. 7, 2024

(51) Int. Cl. H04L 43/022; H04L 43/026; H04L 43/062

(52) U.S. Cl. CPC H04L 43/022; H04L 43/026; H04L 43/062

(57) ABSTRACT

A traffic monitoring device (20) acquires IF statistical data that is statistical information for each IF acquired from a network device and flow statistical data that is statistical information calculated from a sampled packet, from an external storage device that accumulates the IF statistical data and the flow statistical data, and calculates a grand total amount of traffic for each individual flow on the basis of a grand total amount of traffic for each IF calculated from the IF statistical data and a total traffic amount for each flow calculated from the flow statistical data.

### TECHNICAL FIELD

The present invention relates to a traffic monitoring device, a traffic monitoring method, and a traffic monitoring program.

### BACKGROUND ART

In recent years, the importance of traffic collection and analysis has increased for detecting failure or abnormality of an application, service, or the like. As a technique for this purpose, an xFlow technology is known in which traffic is aggregated and analyzed by transferring flow statistical information calculated from header information of a packet or a header portion itself (header sample). Among these xFlow technologies, IPFIX w/IE315 (Non Patent Literature 1) and sFlow (Non Patent Literature 2) of a system for cutting and transferring a header sample are known. In addition, a network (hereinafter, “NW”) device tFlow (Non Patent Literature 3) and IPFIX (Non Patent Literatures 4 to 9) of a system for transferring flow statistical information calculated from header information of a packet are known.

In contrast, as a method of analyzing an encapsulated packet, a format conversion device is known that analyzes the header sample of a sampled encapsulated packet and transmits flow information such as outer/inner header information and flow statistical information such as a traffic amount and the number of packets calculated for each flow (see Patent Literature 1 and Non Patent Literature 10).

Further, the NW device or the like on the network can transmit IF statistical information such as the grand total amount of traffic for each interface (hereinafter, “IF”) of the NW device and the grand total number of packets at regular time intervals by telemetry.

### CITATION LIST

### Patent Literature

Patent Literature 1: JP 2021-090161 A

### Non Patent Literature

Non Patent Literature 1: S. Kashima, and two others, “Information Elements for Data Link Layer Traffic Measurement”, [online], [Searched on May 24, 2022], the Internet <URL: https://www.rfc-editor.org/rfc/rfc7133.html>
Non Patent Literature 2: Peter Phaal, and one other, “sFlow Version 5”, [online], [Searched on May 24, 2022], the Internet <URL: https://sflow.org/sflow_version 5.txt>
Non Patent Literature 3: B. Claise, “Cisco Systems NetFlow Services Export Version 9”, [online], [Searched on May 24, 2022], the Internet <URL: https://www.rfc-editor.org/rfc/rfc3954.txt>
Non Patent Literature 4: B. Trammell, and one other, “Bidirectional Flow Export Using IP Flow Information Export (IPFIX)”, [online], [Searched on May 24, 2022], the Internet <URL: https://www.rfc-editor.org/rfc/rfc5103.txt>
Non Patent Literature 5: B. Claise, and two others, “Specification of the IP Flow Information Export (IPFIX) Protocol for the Exchange of Flow Information”, [online], [Searched on May 24, 2022], the Internet <URL: https://www.rfc-editor.org/rfc/rfc7011.txt>
Non Patent Literature 6: B. Claise, and one other, “Information Model for IP Flow Information Export (IPFIX)”, [online], [Searched on May 24, 2022], the Internet <URL: https://www.rfc-editor.org/rfc/rfc7012.txt>
Non Patent Literature 7: B. Trammell, and one other, “Guidelines for Authors and Reviewers of IP Flow Information Export (IPFIX) Information Elements”, [online], [Searched on May 24, 2022], the Internet <URL: https://www.rfc-editor.org/rfc/rfc7013.txt>
Non Patent Literature 8: S. D'Antonio, and three others, “Flow Selection Techniques”, [online], [Searched on May 24, 2022], the Internet <URL: https://www.rfc-editor.org/rfc/rfc7014.txt>
Non Patent Literature 9: B. Trammell, and two others, “Flow Aggregation for the IP Flow Information Export (IPFIX) Protocol”, [online], [Searched on May 24, 2022], the Internet <URL: https://www.rfc-editor.org/rfc/rfc7015.txt>
Non Patent Literature 10: Nishioka et al., “A Proposal of Fast xFlow Proxy System for Traffic Visualization in Carrier Network Accommodating Multiple Telecom Operators” The Institute of Electronics, Information and Communication Engineers, March 2021, General Conference B-6-33

### SUMMARY OF INVENTION

### Technical Problem

However, in the related art, it is not possible to estimate the grand total amount of traffic for each flow on the basis of flow statistical information of sampled header samples and statistical information for each IF collected by telemetry without collecting header samples of all packets.

For example, in a case where traffic abnormality detection or the like caused by an application or a service is performed, it is necessary to monitor the grand total amount of traffic for each flow of the application or the service. However, in the method of sampling packets by the xFlow technology and obtaining header samples, it is not possible to calculate the grand total amount of traffic for each flow of all the packets that are not sampled. In contrast, in the method of collecting the header samples of all the packets instead of sampling, it is possible to calculate the grand total amount of traffic for each flow, but the number of header samples to be transferred increases, and there is a concern about a significant increase in network load.

In addition, in the method of collecting the statistical information for each IF from the NW device using telemetry, it is possible to collect the grand total amount of traffic for each IF from the NW device, but it is not possible to calculate the grand total amount of traffic for each flow from the grand total amount of traffic for each IF described above.

### Solution to Problem

In order to solve the above problem and achieve the object, a traffic monitoring device of the present invention includes: an acquisition unit that acquires IF statistical data that is statistical information for each IF acquired from a network device and flow statistical data that is statistical information calculated from a sampled packet, from an external storage device that accumulates the IF statistical data and the flow statistical data; and a first calculation unit that calculates a grand total amount of traffic for each individual flow on the basis of a grand total amount of traffic for each IF calculated from the IF statistical data and a total traffic amount for each flow calculated from the flow statistical data.

### Advantageous Effects of Invention

The present invention has an effect that it is possible to estimate the grand total amount of traffic for each flow on the basis of statistical information for each IF collected by telemetry and flow statistical information of sampled header samples without collecting header samples of all packets.

### BRIEF DESCRIPTION OF DRAWINGS

FIG. 1 is a diagram illustrating an example of an overview of traffic monitoring according to an embodiment.

FIG. 2 is a diagram illustrating an example of a device configuration of a data lake and a traffic monitoring device according to the embodiment.

FIG. 3 is a data table diagram illustrating an example of IF statistical data collected by the data lake according to the embodiment.

FIG. 4 is a data table diagram illustrating an example of flow statistical data acquired from the data lake by the traffic monitoring device according to the embodiment.

FIG. 5 is a diagram illustrating an example of calculating the grand total amount of traffic for each flow according to the embodiment.

FIG. 6 is a diagram illustrating an example of calculating the grand total amount of traffic for each flow in an NW device in another area other than a representative area according to the embodiment.

FIG. 7 is a flowchart of data collection and centralized management by the data lake according to the embodiment.

FIG. 8 is a flowchart of calculating the grand total amount of traffic for each flow in the NW device in the representative area by the traffic monitoring device according to the embodiment.

FIG. 9 is a flowchart of calculating the grand total amount of traffic for each flow in the NW device of another area by the traffic monitoring device according to the embodiment.

FIG. 10 is a diagram illustrating an example of a computer on which the data lake and the traffic monitoring device according to the embodiment are implemented.

### DESCRIPTION OF EMBODIMENTS

Hereinafter, a mode for carrying out the present invention (hereinafter, “embodiment”) will be described with reference to the drawings. Note that the present invention is not limited to the embodiment. Further, in the embodiment of the present invention, the “value obtained by adding up the traffic amounts of all the packets meeting a predetermined condition” is defined as the “grand total amount of traffic”, the “value obtained by adding up all the amounts of traffic for each flow of sampling packets meeting the predetermined condition” is defined as the “total traffic amount of all the flows”, and the “value obtained by adding up the traffic amount for each flow the sampling packets matching a predetermined condition only in the flow to be monitored” is defined as the “total traffic amount for each flow”, which will be consistently used below.

### 1. Outline

In the present invention, a data lake 10 (hereinafter, simply “data lake 10”), which is an external storage device, collects telemetry data 50 from an NW device 40 and a flow statistics xFlow packet 52 of an encapsulated packet from a format conversion device 30 and performs centralized management in a network in which a plurality of service networks is superimposed. In addition, a traffic monitoring device 20 acquires IF statistical data 55 including information such as the grand total amount of traffic for each IF and flow statistical data 56 including information such as the traffic amount for each flow of the sampled encapsulated packets from the data lake 10 on the basis of a predetermined condition, calculates the grand total amount of traffic for each flow of the application, service, or the like to be monitored, and monitors traffic.

### 2. Example of Traffic Monitoring According to Embodiment

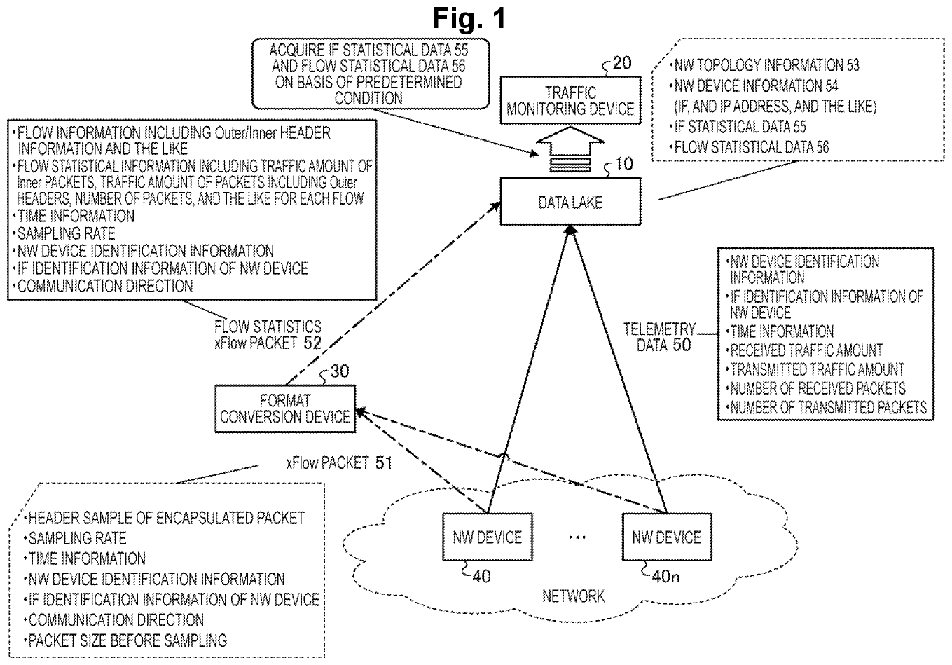

First, an example of processing performed by the data lake 10 and the traffic monitoring device 20 will be described with reference to FIG. 1. FIG. 1 is a diagram illustrating an example of an overview of traffic monitoring according to an embodiment. In FIG. 1, first, the NW device 40, which is a communication device on the network, transmits the telemetry data 50 to the data lake 10. Note that the telemetry data 50 includes “NW device identification information”, “IF identification information of NW device”, “time information”, “received traffic amount”, “transmitted traffic amount”, “number of received packets”, and “number of transmitted packets” acquired by telemetry. Note that the number of NW devices 40 in the network is not limited, and a plurality of NW devices necessary for the network configuration may be included. Furthermore, the telemetry data 50 may include information other than the information described above.

Subsequently, the NW device 40 transmits an xFlow packet 51 of a sampled encapsulated packet to the format conversion device 30. The xFlow packet 51 described above includes “header sample of encapsulated packet”, “sampling rate”, “time information”, “NW device identification information”, “IF identification information of NW device”, “communication direction”, and “packet size before sampling”. Note that the xFlow packet 51 may include information other than the information described above.

Next, the format conversion device 30 that has received the xFlow packet 51 calculates statistical information for each flow from the xFlow packet 51, and transmits a flow statistics xFlow packet 52 to the data lake 10. The flow statistics xFlow packet 52 described above includes “flow information including outer header information, inner header information, and the like”, “flow statistical information including traffic amount of inner packets, traffic amount of packets including outer headers, number of packets, and the like calculated for each flow”, “time information”, “sampling rate”, “NW device identification information”, “IF identification information of NW device”, and “communication direction”. Note that the flow statistics xFlow packet 52 may include information other than the information described above.

Then, the data lake 10 centrally manages NW topology information 53, NW device information 54 such as the IF and the IP address of the NW device constituting the network, information included in the telemetry data 50 (hereinafter, IF statistical data 55), and information included in the flow statistics xFlow packet 52 (hereinafter, flow statistical data 56).

Next, the traffic monitoring device 20 acquires the IF statistical data 55 and the flow statistical data 56 from the data lake 10 on the basis of a predetermined condition. Subsequently, the traffic monitoring device 20 calculates an estimated value of the grand total amount of traffic for each flow of the application, service, or the like to be monitored on the basis of the IF statistical data 55 and the flow statistical data 56 that have been acquired.

### 3. Configuration Example of Data Lake and Traffic Monitoring Device

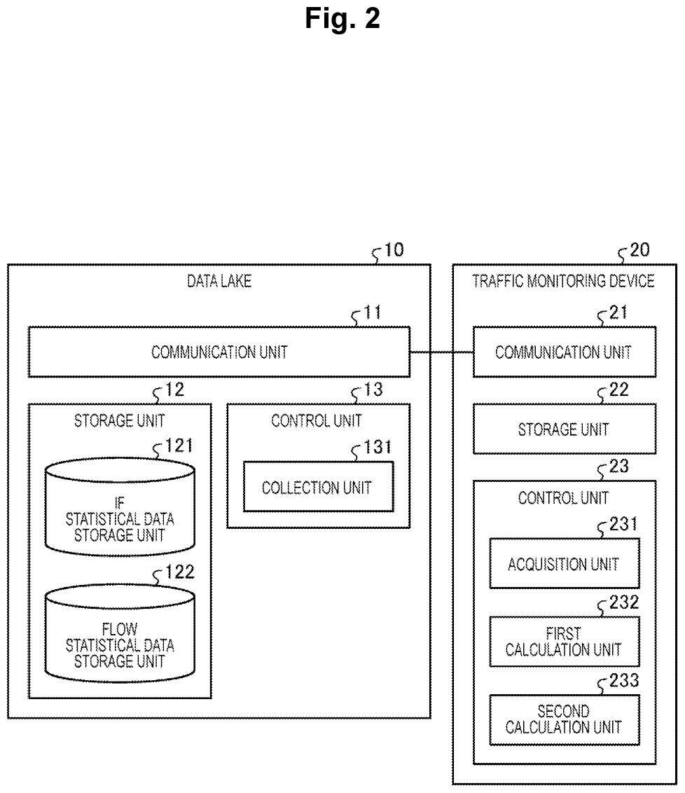

Configurations of the data lake 10 and the traffic monitoring device 20 according to the embodiment will be described with reference to FIG. 2. As illustrated in FIG. 2, the present invention is realized by a device configuration including the data lake 10 and the traffic monitoring device 20. Hereinafter, a detailed function of each unit will be described.

### (Data Lake 10)

The data lake 10 includes a communication unit 11, a storage unit 12, and a control unit 13. Note that, although not illustrated, the data lake 10 may include an input unit (for example, a keyboard, a mouse, and the like) that receives various operations and a display unit (for example, a display or the like) for displaying various types of information.

In addition, the data lake 10 is a device capable of integrally storing structured data and unstructured data. For example, structured data having regularity such as an XML file or a CSV file, and unstructured data such as an image file, a document file, a video file, or an e-mail can be stored in the original format. Note that the data lake 10 may have a function of storing only structured data.

### (Communication Unit 11)

The communication unit 11 of the data lake 10 is implemented by a network interface card (NIC) or the like, and controls communication via a telecommunications line such as a local area network (LAN) or the Internet. The traffic monitoring device 20 to be described later acquires data via the communication unit 11 of the data lake 10 and a communication unit 21 of the traffic monitoring device 20.

### (Storage Unit 12)

The storage unit 12 of the data lake 10 stores data and programs required for various types of processing by the control unit 13. The storage unit 12 includes an IF statistical data storage unit 121 and a flow statistical data storage unit 122. The storage unit 12 is implemented by a semiconductor memory element such as a random access memory (RAM) or a flash memory, or a storage device such as a hard disk or an optical disk.

### (IF Statistical Data Storage Unit 121)

The IF statistical data storage unit 121 stores the IF statistical data 55 on the basis of information included in the telemetry data 50 transmitted from the NW device 40.

### (Flow Statistical Data Storage Unit 122)

The flow statistical data storage unit 122 stores the flow statistical data 56 on the basis of information included in the flow statistics xFlow packet 52 transmitted from the format conversion device 30.

### (Control Unit 13)

The control unit 13 of the data lake 10 includes a collection unit 131. The control unit 13 includes an internal memory for temporarily storing programs and processing data defining various processing procedures and the like, and is implemented by an electronic circuit such as a central processing unit (CPU) or a micro processing unit (MPU), or an integrated circuit such as an application specific integrated circuit (ASIC) or a field programmable gate array (FPGA).

### (Collection Unit 131)

The collection unit 131 collects the IF statistical data 55 on the basis of information included in the telemetry data 50 transmitted from the NW device 40 and the flow statistical data 56 on the basis of information included in the flow statistics xFlow packet 52 transmitted from the format conversion device 30. Note that the data collected by the collection unit 131 is not limited to the information described above, and other information may be collected.

### (Traffic Monitoring Device 20)

Next, the traffic monitoring device 20 will be described. The traffic monitoring device 20 includes the communication unit 21, a storage unit 22, and a control unit 23. Note that, although not illustrated, the traffic monitoring device 20 may include an input unit (for example, a keyboard, a mouse, and the like) that receives various operations and a display unit (for example, a display or the like) for displaying various types of information.

### (Communication Unit 21)

The communication unit 21 of the traffic monitoring device 20 is implemented by an NIC or the like, and controls communication via a telecommunications line such as a LAN or the Internet. The traffic monitoring device 20 acquires data via the communication unit 11 of the data lake 10 described above and the communication unit 21 of the traffic monitoring device 20.

### (Storage Unit 22)

The storage unit 22 of the traffic monitoring device 20 stores data and programs necessary for various types of processing by the control unit 23. The storage unit 22 is implemented by a semiconductor memory element such as a random access memory (RAM) or a flash memory, or a storage device such as a hard disk or an optical disk.

### (Control Unit 23)

The control unit 23 of the traffic monitoring device 20 includes an acquisition unit 231, a first calculation unit 232, and a second calculation unit 233. The control unit 23 includes an internal memory for temporarily storing programs and processing data defining various processing procedures and the like, and is realized by an electronic circuit such as a CPU or an MPU or an integrated circuit such as an ASIC or an FPGA.

### (Acquisition Unit 231)

The acquisition unit 231 acquires the IF statistical data 55, which is statistical information for each IF acquired from the network device and the flow statistical data 56, which is statistical information calculated from sampled packets on the basis of predetermined acquisition conditions from the data lake 10, which is an external storage device that accumulates the IF statistical data 55 and the flow statistical data 56. Then, the acquisition unit 231 acquires from the data lake 10 the IF statistical data 55 and the flow statistical data 56 which have the same NW device identification information, IF identification information and communication direction and measurement times of which are within a predetermined period. Note that the data acquisition conditions may include conditions other than the above. In addition, the traffic amount acquired by the flow statistical data 56 may be the “traffic amount of inner packets” or the “traffic amount of packets including outer headers”.

Here, in a case where the IF statistical data 55 and the flow statistical data 56 hold information in different expressions for the same attribute in the data lake 10, for example, in a case where pieces of different identification information represent the same NW device, the acquisition unit 231 can acquire the data described above from the data lake 10 by holding pieces of identification information for the same attribute in the IF statistical data 55 and the flow statistical data 56 in association with each other in a management device in advance.

### (First Calculation Unit 232)

The first calculation unit 232 adds up the grand total amount of traffic for each IF in a predetermined period of measurement time, the traffic having the same NW device identification information, IF identification information and communication direction, which are information included in the IF statistical data 55 acquired by the acquisition unit 231 in paragraph number 0033, and calculates the grand total amount of traffic of the IF concerned in the predetermined measurement period. Note that in a case where the “traffic amount of inner packets” is acquired in the flow statistical data 56 in paragraph number 0033, the grand total amount of traffic of inner packets for each IF calculated on the basis of the grand total amount of traffic for each IF and the grand total number packets for each IF in the IF statistical data 55 in a predetermined measurement period is added up, and the grand total amount of traffic of the IF concerned in the predetermined measurement period is calculated.

In addition, the first calculation unit 232 calculates an estimated value of the grand total amount of traffic for each individual flow of the application, service, or the like to be monitored on the basis of the total traffic amount in a predetermined measurement period of the traffic amount for each flow of the sampling packets, which is information included in the flow statistical data 56 also acquired by the acquisition unit 231 in paragraph number 0033, and the grand total amount of traffic of the IF concerned described above. The traffic monitoring device 20 specifies the flow of the application or service to be monitored by using only one or a combination of outer header information and inner header information being information included in the flow statistical data 56.

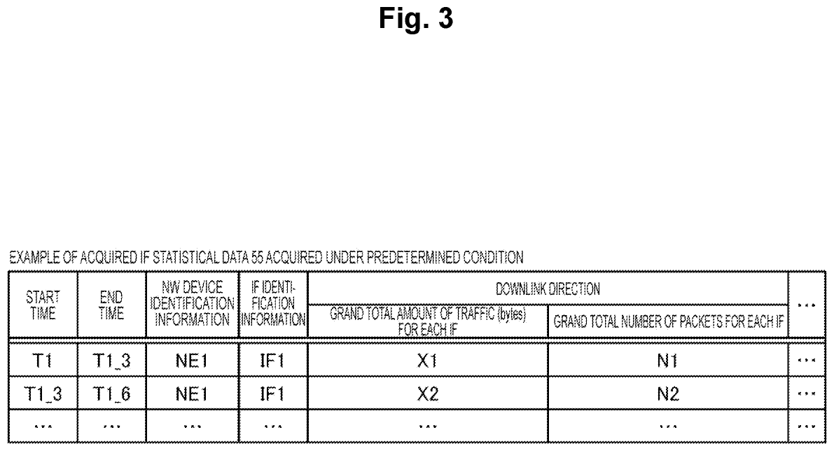

Next, an example in which the acquisition unit 231 acquires the IF statistical data 55 and the flow statistical data 56 and the first calculation unit 232 calculates the estimated value of the grand total amount of traffic of an application k to be monitored in the NW device in a representative area will be described with reference to FIGS. 3 to 5. Note that in the present example, a description will be given by setting the acquisition conditions of the IF statistical data 55 and the flow statistical data 56 as the measurement period “T1 to T2”, the NW device identification information “NE1”, the IF identification information “IF1”, and the communication direction “downlink”.

First, the acquisition unit 231 acquires the IF statistical data 55 matching the above-described data acquisition conditions from the data lake 10. FIG. 3 is an example of the IF statistical data 55 acquired by the acquisition unit 231. For example, the acquisition unit 231 acquires the IF statistical data 55 in which the data of the first row of the table is the start time “T1”, the end time “T1_3”, the NW device identification information “NE1”, the IF identification information “IF1”, the grand total amount of traffic (bytes) for each IF in the downlink direction “X1”, and the grand total number of packets for each IF in the downlink direction “N1”. Note that in a case where the communication direction is set to “uplink” in the acquisition condition, the acquisition unit 231 acquires the IF statistical data 55 in the uplink direction.

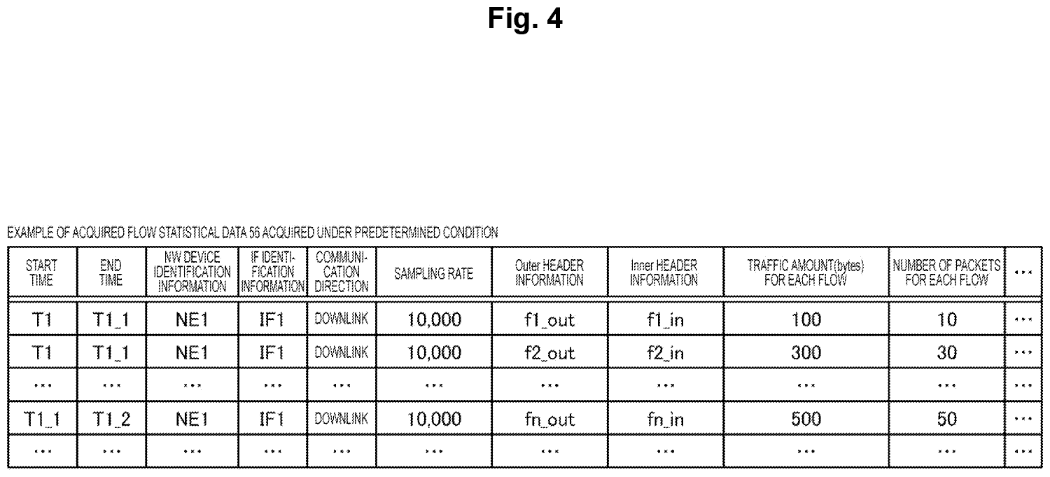

Next, the acquisition unit 231 acquires the flow statistical data 56 matching the above-described data acquisition conditions from the data lake 10. FIG. 4 is an example of the flow statistical data 56 acquired by the acquisition unit 231. For example, the acquisition unit 231 acquires the flow statistical data 56 in which the data of the first row of the table is the start time “T1”, the end time “T1_1”, the NW device identification information “NE1”, the IF identification information “IF1”, the communication direction “downlink”, the sampling rate “10,000”, the outer header information “f1_out”, the inner header information “f1_in”, the traffic amount (bytes) for each flow “100”, and the number of packets for each flow “10”.

Note that although the outer header information of this example is displayed as “f1_out” and the inner header information of this example is displayed as “f1_in” in FIG. 4, the actual outer header information includes a 5-tuple including a source IP address, a source port number, a destination IP address, a destination port number, and a protocol number, a multi-protocol label switching (MPLS) label, and the like, and the actual inner header information includes the 5-tuple and the like described above.

The traffic monitoring device 20 specifies the flow of the application or a service to be monitored by using only one or a combination of a plurality of items such as the port number, the transmission source IP address, and the like included in the 5-tuple of the outer header information and the inner header information described above. Note that the combination of pieces of information such as the 5-tuple for specifying the flow is not limited to the above-described information or combination, and the flow can be specified by other information or another combination.

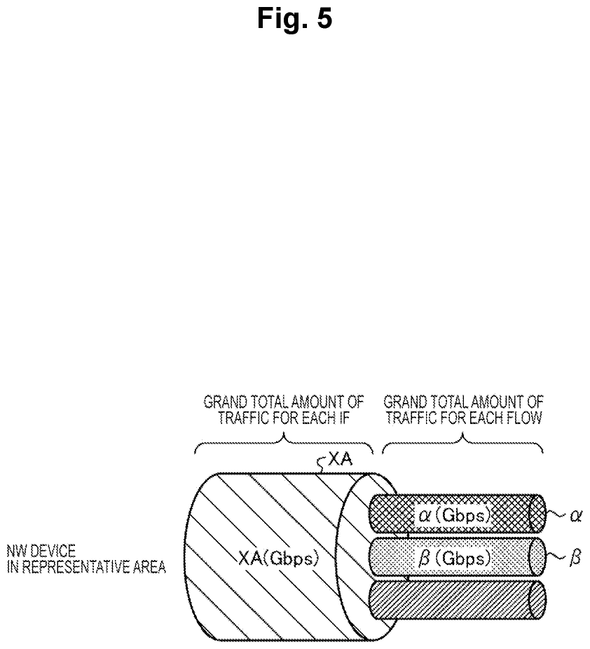

Next, an example of calculating the grand total amount α of traffic of the application k in the NW device in the representative area will be described with reference to FIG. 5. First, the first calculation unit 232 adds up all the traffic amounts (bytes) for each flow in a predetermined period of measurement time, the traffic having the same NW device identification information, IF identification information, and communication direction in the flow statistical data 56 of the sampling packets acquired with respect to the NW device in the representative area by the acquisition unit 231 in paragraph number 0039, and calculates the total traffic amount Sa of all the flows. Subsequently, the first calculation unit 232 extracts data of the application k to be monitored on the basis of the inner header information such as the port number and the server-side IP address in the inner header included in the flow statistical data 56 described above, and calculates the total traffic amount Sk for each flow of the application k.

Next, the first calculation unit 232 calculates the grand total amount α of traffic of the application k in the NW device in the representative area by using the total traffic amount Sa of all the flows, the total traffic amount Sk of the application k, and the grand total amount (bytes) XA of traffic of the IF concerned calculated in paragraph number 0035. For example, the calculation is performed using the following Expression (1).

$$[ Math . 1 ]$$

$$α = \frac{Sk}{Sa} XA \qquad ( 1 )$$

Note that the total traffic amount for each flow of another application may be substituted for Sk of the above-described Calculation Expression (1). For example, the first calculation unit 232 can calculate the grand total amount β of traffic of an application m in the NW device in the representative area by using the total traffic amount Sm of the application m.

### (Second Calculation Unit 233)

The second calculation unit 233 calculates an estimated value of the grand total amount of traffic for each flow in an NW device in an arbitrary area other than the representative area on the basis of the grand total amount of traffic for each IF and the grand total amount of traffic for each flow in the NW device in the representative area calculated by the first calculation unit 232 and the grand total amount of traffic for each IF in the NW device in the arbitrary area.

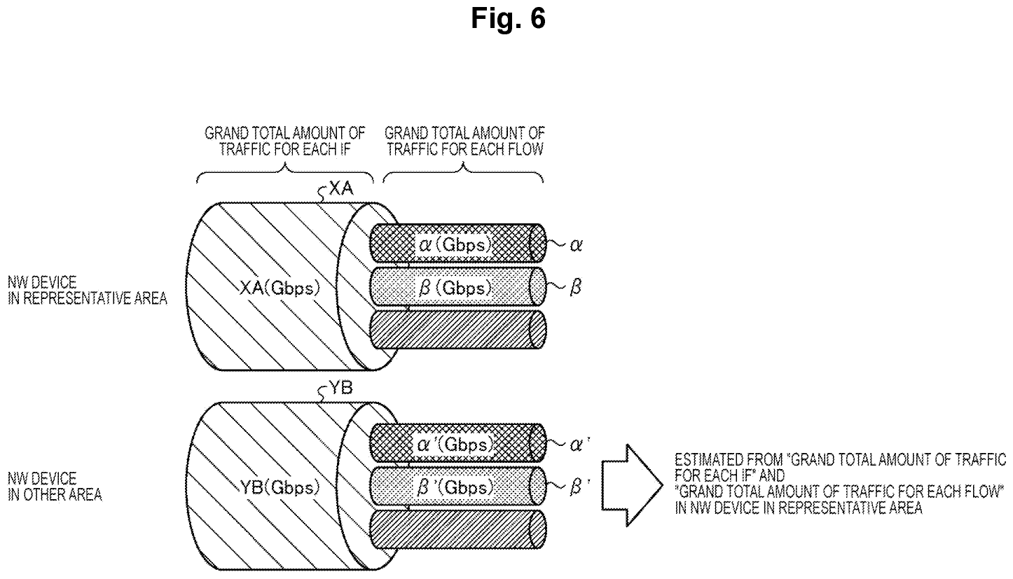

Hereinafter, in FIG. 6, an example will be described in which the grand total amount of traffic for each flow of each application in the NW device in another area is calculated by using the grand total amount of traffic for each flow of each application calculated on the basis of the IF statistical data 55 and the flow statistical data 56 in the NW device in the representative area. Note that, in a carrier network, topology design is performed such that network equipment is uniformly used on the basis of the user distribution, and thus, a geographical tendency difference of traffic observed in a core router is small, and the flow distribution of the application is substantially the same between the representative area in which the flow statistical data 56 is acquired and another area.

First, the acquisition unit 231 acquires IF statistical data 55 in the NW device in another area other than the representative area. The IF statistical data 55 is acquired in which the NW device identification information and IF identification information match those of the NW device in the other area, and the communication direction and the measurement period match those of the data acquisition condition of the IF statistical data 55 acquired when the grand total amount α of traffic of the application k in the NW device in the representative area is calculated. Next, the first calculation unit 232 derives the grand total amount (bytes) YB of traffic of the IF concerned during the predetermined measurement period, with respect to the acquired IF statistical data 55 in the NW device in the other area described above. Subsequently, the second calculation unit 233 calculates the grand total amount α′ of traffic of the application k in the NW device in the other area by using the grand total amount α of traffic of the application k in the NW device in the representative area described above, the grand total amount XA of traffic for each IF in the NW device in the representative area described above, and the grand total amount YB of traffic for each IF in the NW device in the other area, which are calculated by the first calculation unit 232. For example, the calculation is performed using the following Expression (2).

$$[ Math . 2 ]$$

$${α}^{′} = \frac{YB}{XA} α \qquad ( 2 )$$

Note that the grand total amount of traffic for each flow of another application may be substituted for a of the above-described Calculation Expression (2). For example, the second calculation unit 233 can calculate the grand total amount β′ of traffic of the application m in the NW device in the other area by using the grand total amount β of traffic of the application m in the NW device in the representative area.

### 4. Procedure of Traffic Monitoring Method

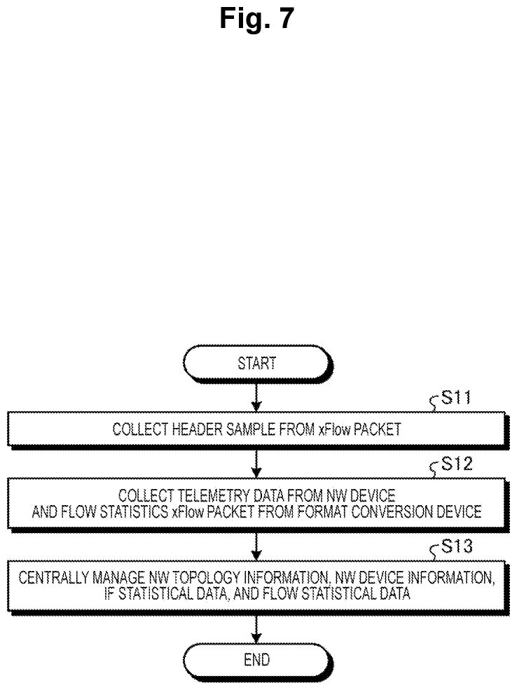

Next, a procedure of a traffic monitoring method by the data lake 10 and the traffic monitoring device 20 will be described with reference to FIGS. 7 to 9. First, a procedure in which the data lake 10 collects data and performs centralized management will be described with reference to FIG. 7.

In FIG. 7, the format conversion device 30 collects a header sample from the xFlow packet 51 (step S11). Next, the data lake 10 collects the telemetry data 50 from the NW device 40 and the flow statistics xFlow packet 52 from the format conversion device 30 (step S12). Then, the data lake 10 centrally manages the NW topology information 53, the NW device information 54, the IF statistical data 55, and the flow statistical data 56 (step S13).

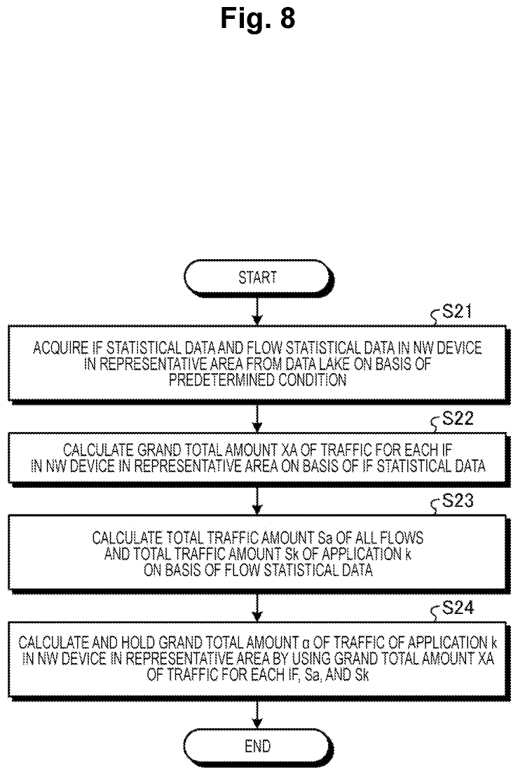

Next, a procedure of calculating the grand total amount of traffic for each flow in the NW device in the representative area by the traffic monitoring device 20 will be described with reference to FIG. 8. First, the acquisition unit 231 acquires the IF statistical data 55 and the flow statistical data 56 in the NW device in the representative area from the data lake 10 on the basis of a predetermined condition (step S21). Next, the first calculation unit 232 calculates the grand total amount XA of traffic for each IF in the NW device in the representative area on the basis of the IF statistical data 55 (step S22). The first calculation unit 232 calculates the total traffic amount Sa of all the flows and the total traffic amount Sk of the application k to be monitored on the basis of the flow statistical data 56 (step S23). Furthermore, the first calculation unit 232 calculates and holds the grand total amount α of traffic of the application k in the NW device in the representative area by using the grand total amount XA of traffic for each IF in the NW device in the representative area, the total traffic amount Sa of all the flows, and the total traffic amount Sk of the application k to be monitored (step S24).

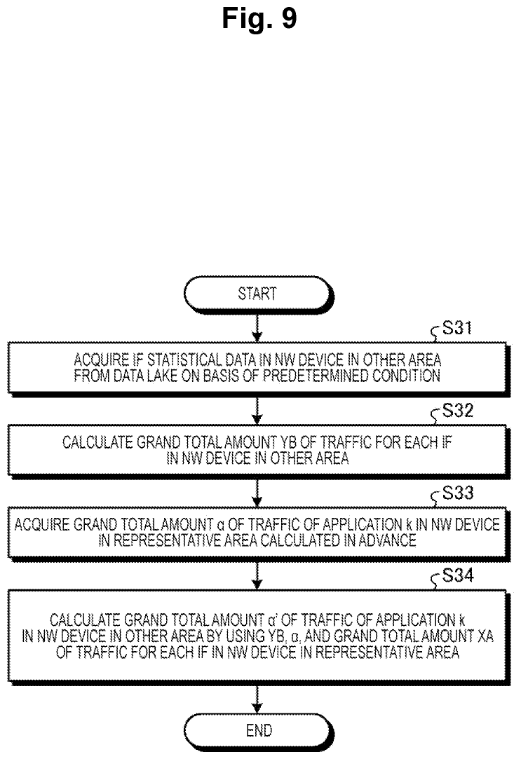

Subsequently, a procedure of calculating the grand total amount of traffic in the NW device in another area by the traffic monitoring device 20 will be described with reference to FIG. 9. First, the acquisition unit 231 acquires the IF statistical data 55 in the NW device in another area from the data lake 10 on the basis of the predetermined condition (step S31). Next, the first calculation unit 232 calculates the grand total amount YB of traffic for each IF in the NW device in the other area (step S32). Subsequently, the second calculation unit 233 acquires the grand total amount α of traffic of the application k in the NW device in the representative area, the grand total amount α of traffic having been calculated in advance by the first calculation unit 232 (S24 in FIG. 8) (step S33). Subsequently, the second calculation unit 233 calculates the grand total amount α′ of traffic of the application k in the NW device in the other area by using the grand total amount YB of traffic for each IF in the NW device in the other area, the grand total amount α of traffic of the application k in the NW device in the representative area, and the grand total amount XA of traffic for each IF in the NW device in the representative area (step S34).

### 5. Effects

As described above, in the present invention, the data lake 10 collects and centrally manages the telemetry data 50 transmitted by the NW device 40 and the flow statistics xFlow packet 52 transmitted by the format conversion device 30. In addition, the traffic monitoring device 20 acquires the IF statistical data 55 and the flow statistical data 56 accumulated in the data lake 10 on the basis of the predetermined condition, and calculates the grand total amount of traffic for each flow of the application or service to be monitored. Therefore, according to the present invention, the following effects are obtained.

### [5-1. Traffic Monitoring for Each Flow]

Since the traffic monitoring device 20 can calculate the grand total amount of traffic for each flow of the application, service, or the like to be monitored, it is possible to monitor traffic for each flow to be monitored for detecting abnormality of the application, service, or the like.

### [5-2. Calculation of Grand Total Amount of Traffic for Each Flow by Low-Load Method]

The traffic monitoring device 20 calculates the grand total amount of traffic for each flow of the application or service to be monitored by using the flow statistical data 56 of sampled header samples without collecting header samples of all the packets and the IF statistical data 55, which is telemetry data having a small data amount. Therefore, the traffic monitoring device 20 can calculate the target grand total amount of traffic by a method with a low load on the network.

### [5-3. Reduction of Traffic Amount on Entire Network]

The traffic monitoring device 20 can calculate the grand total amount of traffic for each flow of the application, service, or the like to be monitored by collecting the header samples only from the NW device in the representative area and acquiring only the IF statistical data 55 regarding the NW device in another area other than the representative area. Therefore, it is possible to reduce the load on the network and the load on the NW device.

### 6. Hardware Configuration

Each component of each device illustrated in the drawings is functionally conceptual and does not necessarily need to be physically configured as illustrated. That is, specific forms of distribution and integration of devices are not limited to the illustrated forms, and some or all of the devices can be functionally or physically distributed and integrated in any units according to various loads, usage conditions, and the like. Furthermore, all or an arbitrary part of each processing function performed in each device can be implemented by a CPU and a program analyzed and executed by the CPU, or can be implemented as hardware by wired logic.

Moreover, among the pieces of processing described in the present embodiment, all or part of the processing described as being automatically performed can be manually performed by a known method. Processing procedures, control procedures, specific names, and information including various types of data and parameters described in the drawings can be arbitrarily changed unless otherwise mentioned.

### [Program]

As one embodiment, it is possible to implement the data lake 10 and the traffic monitoring device 20 by installing a traffic monitoring program for executing the data collection and traffic monitoring described above as package software or online software in a desired computer. For example, by causing an information processing device to execute the traffic monitoring program described above, it is possible to cause the information processing device to function as the data lake 10 and the traffic monitoring device 20. The information processing device mentioned here includes a desktop or a laptop personal computer. In addition, the information processing device also includes a mobile communication terminal such as a smartphone, a mobile phone, and a personal handyphone system (PHS), a slate terminal such as a personal digital assistant (PDA), and the like.

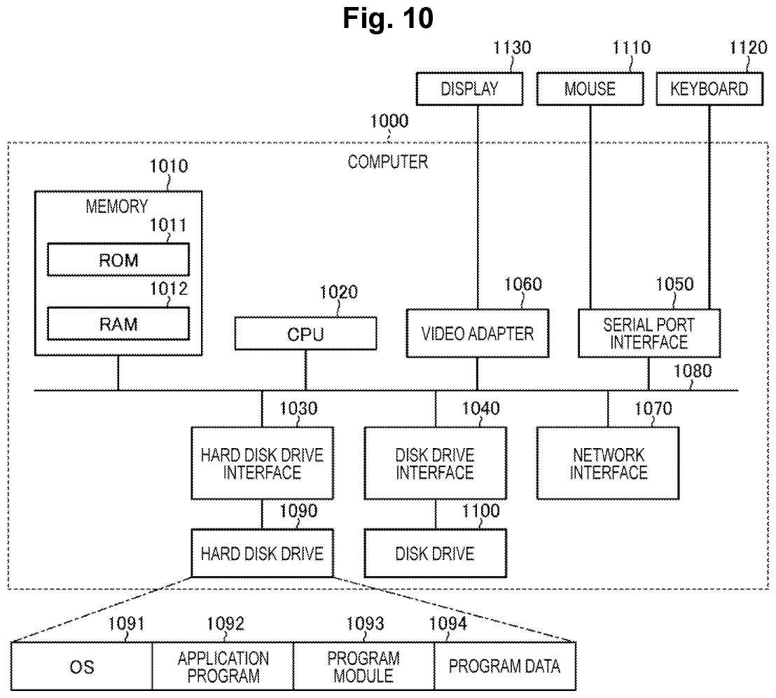

FIG. 10 is a diagram illustrating an example of a computer on which the data lake 10 and the traffic monitoring device 20 are implemented. The computer 1000 includes a memory 1010 and a CPU 1020, for example. The computer 1000 includes a hard disk drive interface 1030, a disk drive interface 1040, a serial port interface 1050, a video adapter 1060, and a network interface 1070. Those units are connected to each other via a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, the program that defines each type of processing of the data lake 10 and the traffic monitoring device 20 is implemented as the program module 1093 in which a code executable by the computer is described. The program module 1093 is stored in, for example, the hard disk drive 1090. For example, the program module 1093 for executing processing similar to the functional configurations in the data lake 10 and the traffic monitoring device 20 is stored in the hard disk drive 1090. Note that the hard disk drive 1090 may be replaced with a solid state drive (SSD).

In addition, setting data used in the processing in the embodiment described above is stored in, for example, the memory 1010 or the hard disk drive 1090 as the program data 1094. Then, the CPU 1020 reads the program module 1093 and the program data 1094 stored in the memory 1010 or the hard disk drive 1090 to the RAM 1012 as necessary and executes the processing in the embodiment described above.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (LAN, wide area network (WAN), or the like). The program module 1093 and the program data 1094 may be read by the CPU 1020 from another computer via the network interface 1070.

### 7. Others

Although the embodiments to which the present invention made by the present inventors is applied have been described above, the present invention is not limited to the description and the drawings which constitute parts of the disclosure of the embodiment of the present invention. In other words, other embodiments, examples, operational techniques, and the like made by those skilled in the art or the like on the basis of the present embodiment are all included in the scope of the present invention.

### REFERENCE SIGNS LIST

10 Data lake
11 Communication unit
12 Storage unit
121 IF statistical data storage unit
122 Flow statistical data storage unit
13 Control unit
131 Collection unit
20 Traffic monitoring device
21 Communication unit
22 Storage unit
23 Control unit
231 Acquisition unit
232 First calculation unit
233 Second calculation unit
30 Format conversion device
40 NW device
50 Telemetry data
51 xFlow packet
52 Flow statistics xFlow packet
53 NW topology information
54 NW device information
55 IF statistical data
56 Flow statistical data
XA Grand total amount of traffic for each IF in NW device in representative area
YB Grand total amount of traffic for each IF in NW device in another area
α Grand total amount of traffic of application k in NW device in representative area
α′ Grand total amount of traffic of application k in NW device in another area
β Grand total amount of traffic of application m in NW device in representative area
β′ Grand total amount of traffic of application m in NW device in another area
Sk Total traffic amount of application k
Sm Total traffic amount of application m
Sa Total traffic amount of all flows
1000 Computer
1010 Memory
1011 ROM
1012 RAM
1020 CPU
1030 Hard disk drive interface
1040 Disk drive interface
1050 Serial port interface
1060 Video adapter
1070 Network interface
1080 Bus
1090 Hard disk drive
1091 OS
1092 Application program
1093 Program module
1094 Program data
1100 Disk drive
1110 Mouse
1120 Keyboard

1. A traffic monitoring device comprising:
an acquisition unit that acquires interface statistical data that is statistical information for each interface acquired from a network device and flow statistical data that is statistical information calculated from a sampled packet, from an external storage device that accumulates the interface statistical data and the flow statistical data; and
a first calculation unit that calculates a grand total amount of traffic for each individual flow on a basis of a grand total amount of traffic for each interface calculated from the interface statistical data and a total traffic amount for each flow calculated from the flow statistical data.

2. The traffic monitoring device according to claim 1, further comprising:
a second calculation unit that calculates the grand total amount of traffic for each flow in a network device in an arbitrary area other than a representative area on a basis of the grand total amount of traffic for each interface and the grand total amount of traffic for each flow in the network device in the representative area and the grand total amount of traffic for each interface in the network device in the arbitrary area.

3. A traffic monitoring method comprising:
acquiring interface statistical data that is statistical information for each interface acquired from a network device and flow statistical data that is statistical information calculated from a sampled packet, from an external storage device that accumulates the interface statistical data and the flow statistical data; and
calculating a grand total amount of traffic for each individual flow on a basis of a grand total amount of traffic for each interface calculated from the interface statistical data and a total traffic amount for each flow calculated from the flow statistical data.

4. A computer-readable non-transitory recording medium storing computer-executable program instructions that when executed by a processor cause a computer to execute a traffic monitoring program comprising:
acquiring interface statistical data that is statistical information for each interface acquired from a network device and flow statistical data that is statistical information calculated from a sampled packet, from an external storage device that accumulates the interface statistical data and the flow statistical data; and
calculating a grand total amount of traffic for each individual flow on a basis of a grand total amount of traffic for each interface calculated from the interface statistical data and a total traffic amount for each flow calculated from the flow statistical data.

5. The traffic monitoring method according to claim 3, further comprising:
calculating the grand total amount of traffic for each flow in a network device in an arbitrary area other than a representative area on a basis of the grand total amount of traffic for each interface and the grand total amount of traffic for each flow in a network device in the representative area and the grand total amount of traffic for each interface in the network device in the arbitrary area.

6. The computer-readable non-transitory recording medium according to claim 4 wherein the traffic monitoring method further comprising:
calculating the grand total amount of traffic for each flow in a network device in an arbitrary area other than a representative area on a basis of the grand total amount of traffic for each interface and the grand total amount of traffic for each flow in a network device in the representative area and the grand total amount of traffic for each interface in the network device in the arbitrary area.
